(19) United States
(12) Patent Application Publication
(10) Pub. No.: US 2017/0201028 A1
(43) Pub. Date: Jul. 13, 2017

(54) Printed Circuit Board Mounted Antenna and Waveguide Interface

(71) Applicant: Mimosa Networks, Inc., Santa Clara, CA (US)

(72) Inventors: Paul Eberhardt, Santa Cruz, CA (US); Syed Aon Mujtaba, Santa Clara, CA (US); Brian L. Hinman, Los Gatos, CA (US)

(21) Appl. No.: 15/403,085

(22) Filed: Jan. 10, 2017

Related U.S. Application Data
(60) Provisional application No. 62/277,448, filed on Jan. 11, 2016.

(51) Int. Cl. H01Q 13/12; H01P 5/08; H01Q 9/04; H01Q 1/38; H01Q 1/48; H01P 3/127; H01P 3/06

(52) U.S. Cl. CPC H01Q 13/12; H01P 3/127; H01P 5/082; H01P 3/06; H01Q 1/38; H01Q 1/48; H01Q 9/0407

(57) ABSTRACT

Printed circuit board mounted antenna and waveguide interfaces are provided herein. An example device includes any of a dielectric substrate or transmission line, an antenna mounted onto the dielectric substrate, and an elongated waveguide mounted onto the dielectric substrate so as to enclose around a periphery of the antenna and contain radiation produced by the antenna along a path that is coaxial with a centerline of the waveguide.

### CROSS REFERENCE TO RELATED APPLICATION

This application claims the benefit and priority of U.S. Provisional Application Ser. No. 62/277,448, filed on Jan. 11, 2016, which is hereby incorporated by reference herein including all references and appendices cited therein.

### FIELD OF THE PRESENT DISCLOSURE

The present disclosure relates generally to transition hardware between waveguide transmission lines and printed circuit and/or coaxial transmission lines. This present disclosure describes embodiments with an antenna feed but it is not specifically limited to that particular application.

### SUMMARY

According to some embodiments, the present disclosure is directed to a device that comprises: (a) a dielectric substrate; (b) an electrical feed; (b) an antenna mounted onto the dielectric substrate and connected to the electrical feed; and (c) an elongated waveguide mounted onto the dielectric substrate so as to enclose around a periphery of the antenna and contain radiation produced by the antenna along a path that is coaxial with a centerline of the waveguide.

According to some embodiments, the present disclosure is directed to a device that comprises: (a) a dielectric substrate comprising an electrical feed that comprises at least one of a printed circuit transmission line and a coaxial cable; (b) a metallic layer applied to the dielectric substrate and connected to the electrical feed, wherein the metallic layer comprises a slot radiator; and (c) an elongated waveguide mounted onto the dielectric substrate so as to enclose around a periphery of the slot radiator and contain and direct radiation produced within the slot radiator along a path that is coaxial with a centerline of the waveguide.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a perspective view of an example device constructed in accordance with the present disclosure, having a waveguide of transitional cross section along its length.

FIG. 2 is a perspective view of an example device constructed in accordance with the present disclosure, having a waveguide of uniform cross section along its length. In general, the waveguide cross section could be changed. For example the shape in the immediate vicinity could have a particular shape and that shape could be modified to interface with a waveguide with another cross section as one example for such a change.

FIG. 3 is a top down view of an example device constructed in accordance with the present disclosure.

FIG. 4 is a cross sectional view of an example device constructed in accordance with the present disclosure.

FIG. 5 is a perspective view of an example device constructed in accordance with the present disclosure, having a waveguide of transitional cross section along its length, and having both a polygonal section and a cylindrical section.

FIG. 6 is a perspective, partial cutaway view of another example device constructed in accordance with the present disclosure that comprises a slot antenna element.

FIG. 7 is a perspective, partial cutaway view of another example device constructed in accordance with the present disclosure that comprises a slot antenna element and comprising a cylindrical waveguide.

### DESCRIPTION OF EXEMPLARY EMBODIMENTS

Generally, the present disclosure is directed to waveguides that are mounted directly to a printed circuit board. These waveguides can have any variety of geometrical shapes and cross sections. The shape and/or cross section of a waveguide can be continuous along its length or can vary according to various design requirements such as impedance matching and/or for frequency tuning of the radiation emitted by the patch antenna or slot antenna incorporated into the printed circuit board. These and other advantages of the present disclosure are described in greater detail infra. Current practice is to excite a waveguide with a probe or monopole antenna. The probe can be a wire attached to a coaxial transmission or a feature imbedded in a PCB. This technique produces waves traveling in both directions down a waveguide. The backward going wave is usually reflected by a shorting plate in the waveguide, typically placed a quarter of a wavelength away from the feed probe. This disclosure contemplates launching a wave traveling in only one direction, thus, simplifying the construction of the interface and making it more robust.

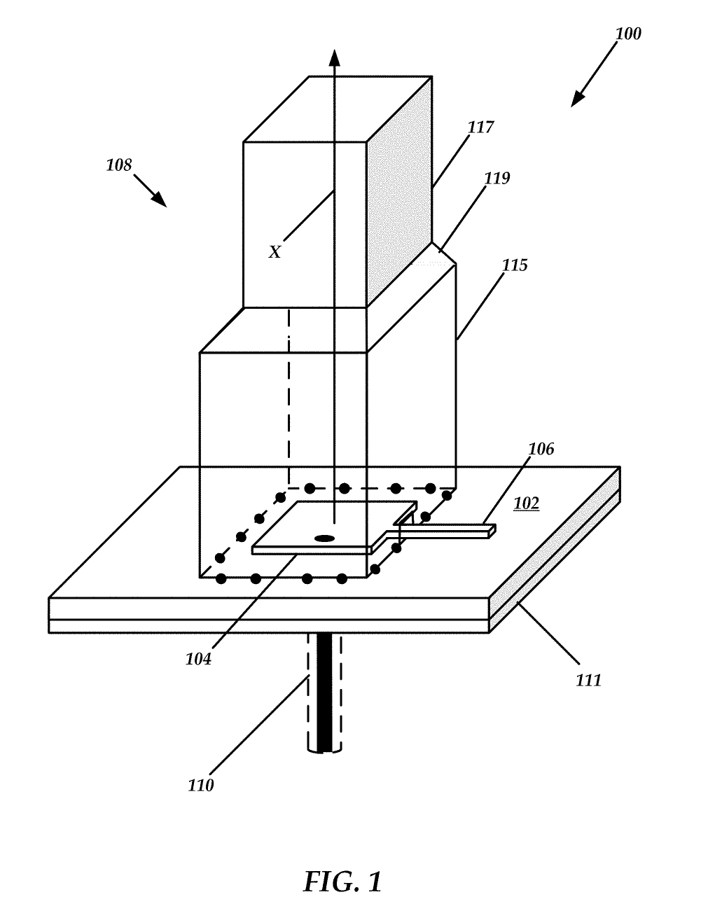

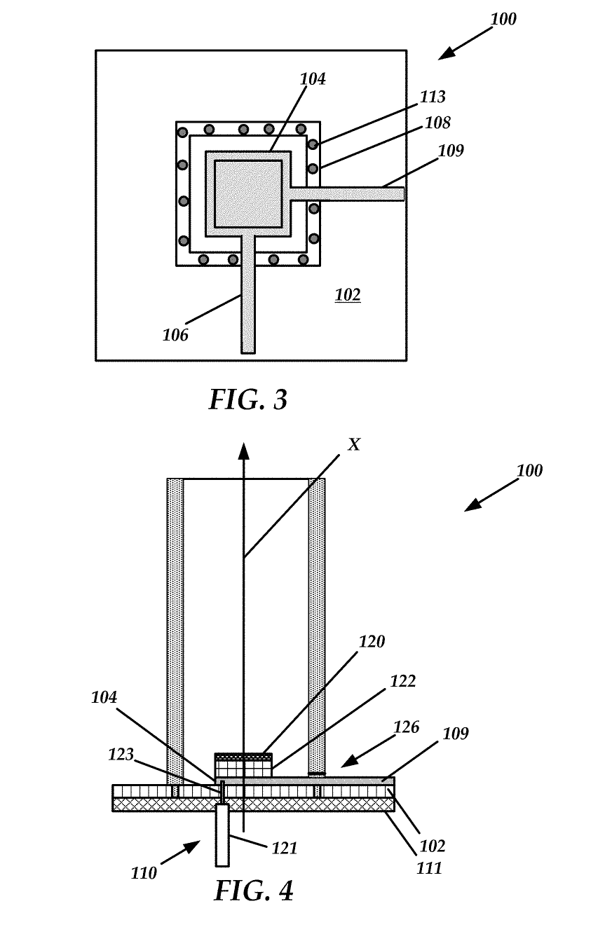

FIG. 1 is an example device 100 that is constructed in accordance with the present disclosure. The device 100 comprises a dielectric substrate 102, an antenna 104, a feed strip 106, a waveguide 108, and a ground plane 111. The device 100 can include additional or fewer components than those illustrated. A single feed strip 106 is illustrated but device 100 is not so limited. Additional feed strips can be utilized in some embodiments. The feed strip 106 can comprise a printed circuit transmission line, in some embodiments (as illustrated in FIG. 3).

The dielectric substrate 102 can comprise any suitable PCB (printed circuit board) substrate material constructed from, for example, one or more dielectric materials. The antenna 104 is mounted onto the dielectric substrate 102. In one embodiment the antenna 104 is a patch antenna. In another embodiment, the antenna 104 is a multi-stack set of antennas. In some embodiments, the antenna 104 is electrically coupled with one or more printed circuit transmission lines (such as two or more feed strips 106 as illustrated in FIG. 3).

Various embodiments of the waveguide 108 are illustrated in FIGS. 1-7. While the waveguide 108 is generally elongated, the waveguide 108 can comprise a truncated or short embodiment of a waveguide.

For context, without the waveguide 108, the antenna 104 emits signal radiation in a plurality of directions, causing loss of signal strength, reduced signal directionality, as well as cross-port interference (e.g., where an adjacent antenna is affected by the antenna 104).

Thus, in various embodiments, the waveguide 108 is mounted directly to the dielectric substrate 102, around a periphery of the antenna 104. The spacing between the waveguide 108 and the antenna 104 can be varied according to design parameters.

In one embodiment the waveguide 108 encloses the antenna 104 and captures the radiation of the antenna 104, directing it along and out of the waveguide 108. The waveguide 108 is constructed from any suitable conductive material. The use of the waveguide 108 allows one to transfer signals from one location to another location with minimal loss or disturbance of the signal.

In various embodiments, the length of the waveguide 108 is selected according to design requirements, such as required signal symmetry. The waveguide 108 can have any desired shape and/or size and length. The illustrated waveguide 108 is rectangular in shape, but any polygonal, cylindrical, or irregular shape can be implemented as desired.

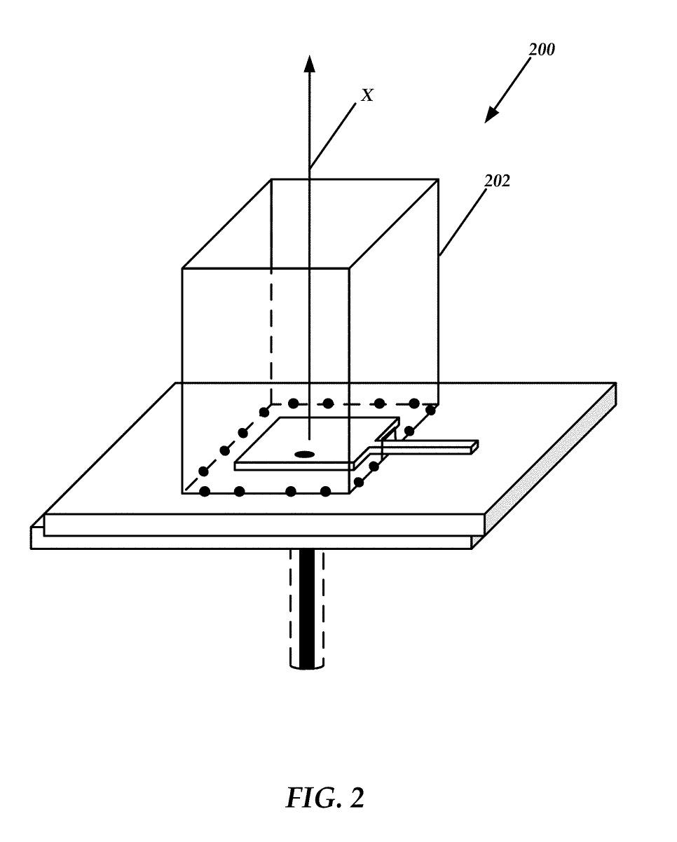

FIG. 2 illustrates another device 200 that is constructed identically to the device 100 of FIG. 1 with the exception that the waveguide 202 has a continuous cross section along its entire length.

As illustrated in FIG. 3, the waveguide 108 is coupled to the ground plane 111 (not shown in FIG. 3) through conductive vias, such as via 113, which extend through the dielectric substrate 102, in some embodiments. Also, as mentioned above, the antenna 104 is coupled with two printed circuit transmission lines (i.e. feed strips) 106 and 109. In various embodiments, the use of two feed lines (or feed lines and coaxial cables) allows for dual linear (or dual circular) polarization. Additional feeds could be used to excite multiple, higher order modes in a particular waveguide. The use of this feed in conjunction with a Potter horn is one possible application for the excitation of multiple, simultaneous, higher order modes.

Indeed, feed lines/strips as well as coaxial cables as described herein can be generally referred to as an electrical feed.

Referring back to FIG. 1, in some embodiments, the waveguide 108 can comprise two sections of different size and/or cross section from one another. For example, the waveguide 108 of FIG. 1 comprises a first portion 115 having a rectangular cross section. The waveguide 108 comprises a second portion 117 that also has a rectangular cross section. The first portion 115 transitions to the second portion 117 using a transition section 119. The slope or angle of the sides of the transition section 119 can vary according to design requirements.

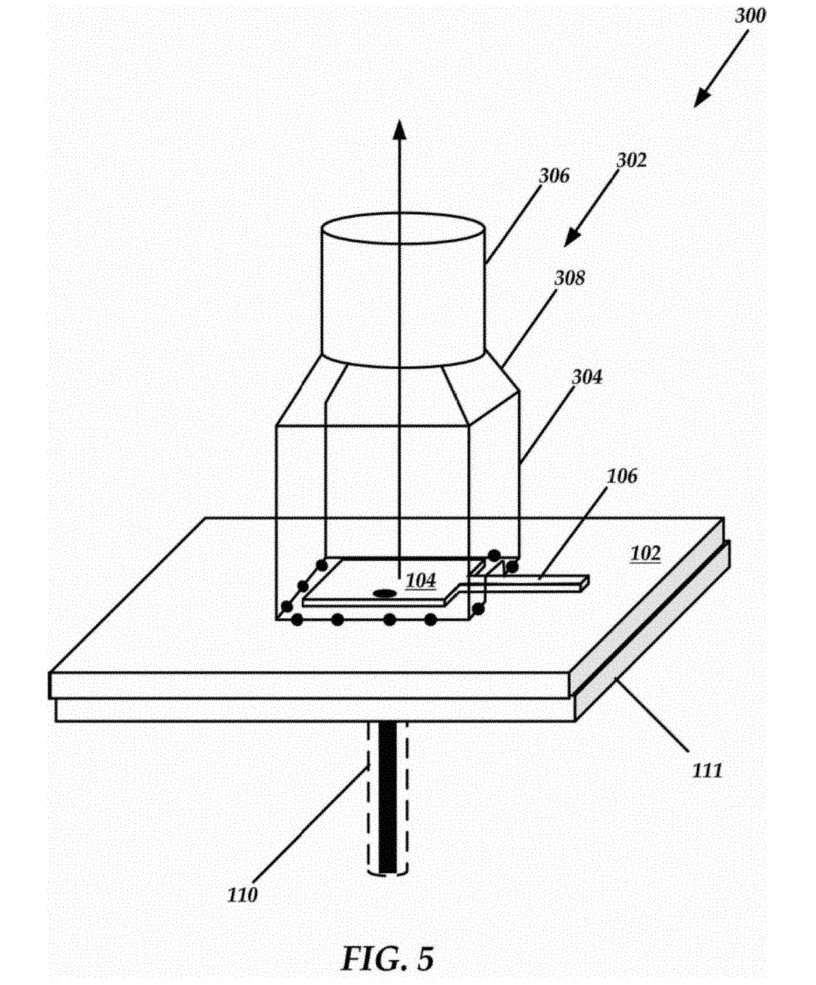

In various embodiments, the transition section 119 allows the shape of the signal radiation that is emitted to be changed. For example, the transition section 119 can be circular in shape while the waveguide 108 is square, such as illustrated in FIG. 5. This allows for optimum radiation reflection and symmetry near the antenna 104, while providing a desired emitted signal shape through the transition section 119.

The waveguide 108 contains radiation produced by the antenna 104 and directs the radiation along a path that is coaxial with a centerline X of the waveguide 108, in some embodiments.

In various embodiments, the selection of dielectric materials for the waveguide 108 can be used to effectively adjust a physical size of either the waveguide and/or antenna patch while keeping the electrical characteristics compatible.

Referring to FIG. 1, in some embodiments, the antenna 104 is coupled with a coaxial cable 110 to a signal source such as a radio. In other embodiments, the antenna 104 is coupled to a radio (not shown) with a PCB (printed circuit board) based transmission line or feed strip 106. In some embodiments, the coaxial cable 110 is used in place of the feed strip 106. In some embodiments, the coaxial cable 110 is used in combination with one or more feed strips 106.

Advantageously, the device 100 provides high levels of signal isolation between adjacent feeds, in various embodiments. The device 100 can also allow for linear or circular waves to be easily directed as desired. A narrow or wide bandwidth transition can be utilized, in some embodiments.

The present disclosure is not limited to using a single planar patch antenna when other antennas are advantageous. For example, inverted F-antennas, cavity backed slots, and planar inverted F-antennas can also be utilized. Multiple patches and feeds, slightly displaced in the waveguide could be used, for example, to increase bandwidth. This idea is fundamental to how a log-periodic dipole works.

FIG. 4 illustrates the use of a parasitic patch 120 that is placed in a spaced apart relationship to the antenna 104. Again, the ground plane 111 is placed below the dielectric substrate 102 and the antenna 104 is mounted to the dielectric substrate 102. In some embodiments, the antenna 104 is partially or totally embedded in the dielectric substrate 102. The parasitic patch 120 is placed above the antenna 104. In some embodiments a spacer 122 is placed between the parasitic patch 120 and the antenna 104. In one or more embodiments, the spacer 122 comprises a Mylar sheet, a foam block, a low-density plastic block, or other similar material that does not impede (or has very low impedance or absorption of) the radiation emitted from the antenna 104. In general, the parasitic patch 120 functions to improve bandwidth and other operational parameters of the device 100. In some embodiments, a perimeter of the parasitic patch 120 is smaller than a perimeter of the antenna 104.

In some embodiments, a coaxial cable 110 comprises an outer section 121 that is in electrical contact with the ground plane 111 and an inner section 123 that is in electrical contact with the antenna 104.

According to some embodiments, the waveguide 108 comprises an aperture or pass through 126 that allow the feed strip 106 to enter the waveguide 108 without contacting the waveguide 108.

FIG. 5 illustrates another device 300 of embodiments of the present technology that is constructed identically to the device 100 of FIG. 1 with the exception that the waveguide 302 has a first section 304 that has a polygonal cross section and a second section 306 that has a cylindrical cross section. A transition section 308 couples the first section 304 and the second section 306.

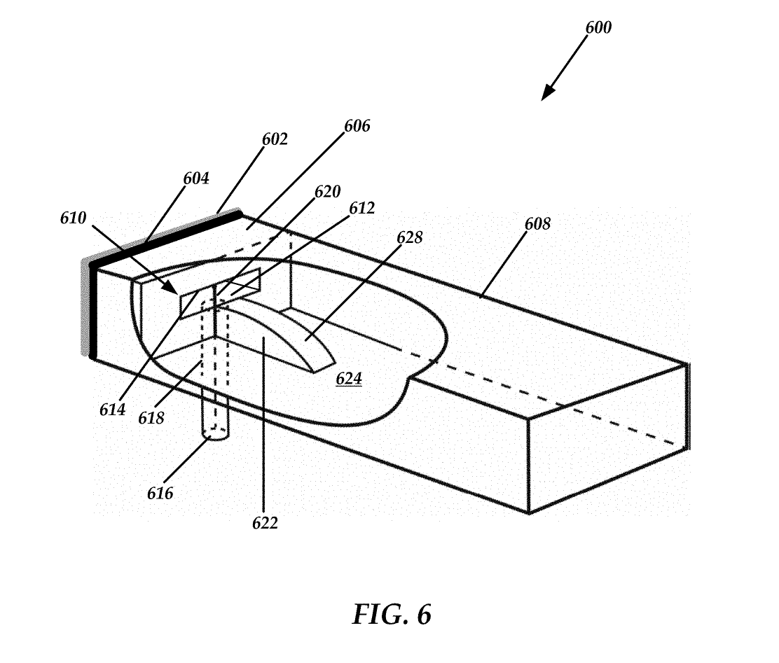

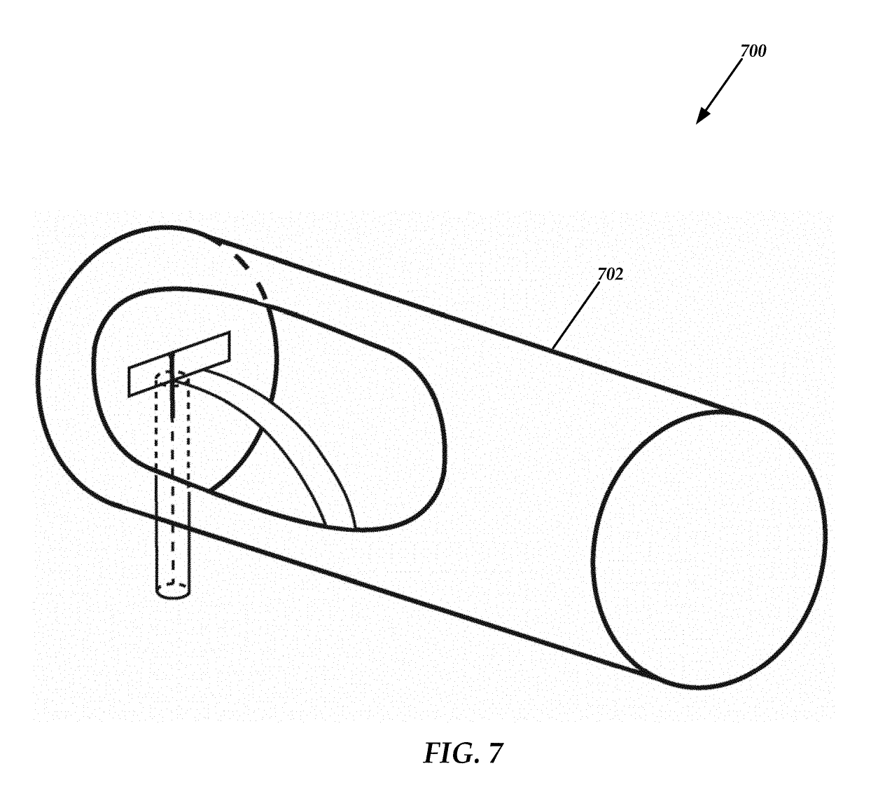

FIG. 6 illustrates another device 600 of embodiments of the present disclosure. The device 600 comprises a ground plane 602, a dielectric substrate 604, a metallic layer 606, and a rectangular waveguide 608. The transition between the dielectric substrate 604 and the rectangular waveguide 608 is accomplished using a slot radiator 610 located inside the rectangular waveguide 608.

In various embodiments, the slot radiator 610 is created within the metallic layer 606 which comprises an aperture or notch that defines the slot radiator 610. The slot radiator 610 is defined by a sidewall that includes at least a first side 612 and a second side 614.

In some embodiments, the slot radiator 610 is coupled with a coaxial cable 616, although a feed strip (printed circuit transmission line) can be used as well. In one embodiment, an outer section 618 of the coaxial cable 616 terminates at the first side 612 of the slot radiator 610 and an inner section 620 of the coaxial cable 616 terminates at the second side 614 of the slot radiator 610. That is, the inner section 620 of the coaxial cable 616 extends across an opening of the slot radiator 610 in the space that exists between the first side 612 and the second side 614.

In various embodiments, a variety of methods may be used to excite the slot radiator 610, which may be cavity backed. While the coaxial cable 616 is illustrated as connecting to the slot radiator 610 perpendicularly, the feed (i.e. either the coaxial cable 616 or feed lines/strips) could also be couple with a back of the rectangular waveguide 608.

In some embodiments, the device 600 comprises a tapered ridge 622. The tapered ridge 622 contacts an inner surface 624 of the rectangular waveguide 608 and abuts the slot radiator 610. In one or more embodiments, the tapered ridge 622 comprises an arcuate surface 628 that abuts the slot radiator 610 and terminates against the inner surface 624 of the rectangular waveguide 608.

In one or more embodiments, the tapered ridge 622 is aligned with a centerline of the slot radiator 610. The tapered ridge 622 can also be offset from the slot radiator 610 in other embodiments.

The depicted rectangular waveguide 608 in FIG. 6 is rectangular, but other waveguide contours are practical in various embodiments of the present technology, including but not limited to square, circular, and elliptical cross sections. For example, FIG. 7 illustrates another device 700 with a cylindrical waveguide 702. Some of the details of the device 700 have been omitted such as the ground plane and dielectric substrate.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

While this technology is susceptible of embodiment in many different forms, there is shown in the drawings and has been described in detail several specific embodiments with the understanding that the present disclosure is to be considered as an exemplification of the principles of the technology and is not intended to limit the technology to the embodiments illustrated.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A device, comprising:
a dielectric substrate;
an electrical feed;
an antenna mounted onto the dielectric substrate and connected to the electrical feed; and
an elongated waveguide mounted onto the dielectric substrate so as to enclose around a periphery of the antenna and contain radiation produced by the antenna along a path that is coaxial with a centerline of the waveguide.

2. The device according to claim 1, further comprising a ground plane mounted to a lower surface of the dielectric substrate.

3. The device according to claim 2, wherein the elongated waveguide is coupled with the ground plane through a series of conductive vias that extend through the dielectric substrate.

4. The device according to claim 1, wherein the electrical feed comprises a coaxial cable comprising an outer portion that is in electrical contact with the dielectric substrate and an inner portion that is in electrical contact with the antenna.

5. The device according to claim 1, wherein the antenna comprises a patch antenna.

6. The device according to claim 1, wherein the elongated waveguide has a polygonal cross sectional area.

7. The device according to claim 1, wherein the elongated waveguide has a cylindrical cross sectional area.

8. The device according to claim 1, wherein the elongated waveguide has a first section with a polygonal cross sectional area and a second section with a geometrical configuration that is different from the first section, further comprising a transition section that couples the first section with the second section.

9. The device according to claim 8, wherein the second section has a cylindrical cross sectional area.

10. The device according to claim 1, further comprising a parasitic patch disposed in a spaced apart relationship above the antenna.

11. The device according to claim 10, further comprising a spacer disposed between the parasitic patch and the antenna.

12. A device, comprising:
a dielectric substrate comprising an electrical feed that comprises at least one of a printed circuit transmission line and a coaxial cable;
a metallic layer applied to the dielectric substrate, wherein the metallic layer comprises a slot radiator and is connected to the electrical feed; and
an elongated waveguide mounted onto the dielectric substrate so as to enclose around a periphery of the slot radiator and to contain and direct radiation produced within the slot radiator along a path that is coaxial with a centerline of the elongated waveguide.

13. The device according to claim 12, wherein the coaxial cable comprises an inner portion and an outer portion, wherein the outer portion of the coaxial cable terminates on a first side of the slot radiator and the inner portion of the coaxial cable extends across on opening of the slot radiator and contacts a second side of the slot radiator.

14. The device according to claim 12, further comprising a tapered ridge that extends along an inner surface of the elongated waveguide, the tapered ridge comprising an arcuate surface that abuts the slot radiator and terminates against the inner surface of the elongated waveguide.

15. The device according to claim 12, wherein the elongated waveguide has a polygonal cross sectional area.

16. The device according to claim 12, wherein the elongated waveguide has a cylindrical cross sectional area.
